(19) United States
(12) Patent Application Publication
(10) Pub. No.: US 2025/0110484 A1
(43) Pub. Date: Apr. 3, 2025

(54) ESTIMATION OF GREENHOUSE GAS EMISSIONS BASED ON A PRODUCTION PLAN

(71) Applicant: Honeywell International Inc., Charlotte, NC (US)

(72) Inventors: Sandhya Beejady, Bangalore (IN); Rajapriyan Thambidurai, Bangalore (IN); Sridhar Sankaranarayanan, Bangalore (IN); Dhandapani Krishnasamy, Hosur (IN); Madhukar Gundappa, Bangalore (IN)

(21) Appl. No.: 18/757,503

(22) Filed: Jun. 28, 2024

Related U.S. Application Data
(60) Provisional application No. 63/540,959, filed on Sep. 28, 2023.

(51) Int. Cl. G05B 19/418

(52) U.S. Cl. CPC G05B 19/41865; G05B 19/4183

(57) ABSTRACT

Approaches for estimating emission intensity based on a proposed production plan are described. In an example, the emission intensity may be determined based on a weighted distribution of greenhouse gas emissions corresponding to an emission source. Emission source may further include a contributing category, with the contributing category further comprising a source level category. In an example, the weighted distribution may correspond to each of the contributing category and the source level category. In such a case, a first weighted distribution corresponding to a source level category indicates the contribution of greenhouse gas emissions by the source level category to the contributing category. In a similar manner, a second weighted distribution corresponding to the contributing category may depict the contribution of greenhouse gas emissions to the emission source.

### BACKGROUND

Rapid urbanization and globalization have caused an immense increase in greenhouse gas (GHG) emissions in the world. GHG emissions primarily come from burning fossil fuels for energy, as well as from production of goods from raw materials. The increase of GHG emissions may be reduced by reducing the use of fossil fuels, and replacing their use with greener alternatives, like renewable energy sources, or by employing corrective measures for treating emissions to reduce the quantities of the GHG within the emissions. Generally, estimating greenhouse gas emissions assists in defining emission reduction targets and aids in assessing whether an organization is on a track to meet its existing target. Based on such estimations, the organization may evaluate and plan strategic sustainable measures for reducing carbon emissions.

### BRIEF DESCRIPTION OF DRAWINGS

Systems and/or methods, in accordance with examples of the present subject matter are now described and with reference to the accompanying figures, in which:

FIG. 1 illustrates an emission estimation system for estimation of emissions based on production plan, in accordance with an example of the present subject matter.

FIG. 2 illustrates an environment for estimation of emissions based on production plan, in accordance with another example of the present subject matter.

FIG. 3 illustrates an example environment for estimation of emissions based on production plan, in accordance with an example implementation of the present subject matter.

FIG. 4 illustrates an example emission estimation system for estimation of emissions based on production plan, in accordance with an example implementation of the present subject matter.

FIG. 5 illustrates a graphical user interface displaying estimation of emissions, in accordance with another example implementation of the present subject matter.

FIG. 6 illustrates a method for estimation of greenhouse gas emissions in a facility, in accordance with yet another example implementation of the present subject matter.

FIG. 7 illustrates a method for estimation of greenhouse gas emissions, as per an example, in accordance with yet another example implementation of the present subject matter.

FIG. 8 illustrates a method for estimation of greenhouse gas emissions, as per an example, in accordance with yet another example implementation of the present subject matter.

FIG. 9 illustrates a non-transitory computer-readable medium for estimation of emissions based on production plan, in accordance with an example implementation of the present subject matter.

### DETAILED DESCRIPTION

GHG emissions may be produced as a result of one or more processes that may be implemented within an industrial, commercial or a similar facility of an organization. Such processes may be for manufacturing of goods or for providing services. The emissions may be indicated as a volume or gross weight of the GHG emissions produced during such processes. The quantity of the emissions may be directly dependent on the quantity of goods produced or the extent of activities that may be performed as part of the processes. Although dependent on the quantity of goods produced (or the extent of activity that may have been performed), the quantity or amount of the emissions may not correctly indicate the efficiency of the underlying process.

The emissions produced may also be indicated by way of emissions intensity. Emissions intensity or emission intensity, in the context of an industrial process, for example, in an oil and gas industry, may be considered as a ratio of the overall emissions (measured in terms of the volume of the greenhouse gases produced) to the quantity of the goods produced through the industrial process. Such a representation would thus depict the net emissions produced for a unit quantity of goods produced. For example, for industrial steel, the emission intensity may represent volume or quantity of carbon dioxide produced for industrial a metric ton of steel. In this manner, emission intensity may be prescribed for a variety of products or goods.

The Greenhouse Gas Protocol categorizes emissions as one of a direct emission and an indirect emission. The emissions in turn may be from a direct source, wherein such emissions are referred to as Scope 1 emissions, as per the Greenhouse Gas Protocol. Such direct sources may be machinery, equipment or other infrastructure components that may be operating to implement manufacturing processes within a facility owned or managed by an organization. Examples include, but are not limited to, emissions produced as a result of burning fuel for producing energy for a given manufacturing process. On the other hand, emissions from indirect sources are referred to as Scope 2 or Scope 3 emissions. For example, Scope 2 emissions are such emissions that an organization causes indirectly and are produced as a result of generating energy procured and used by the organization. Other indirect sources of emissions arising from activities caused by the organization, in a value chain may be referred to as Scope 3 emissions.

Particularly, with respect to the emission intensity produced from the oil and gas industry, the emissions may arise from a variety of sources, for example, extraction of oil and gas which involves utilization of large amounts of energy to power a variety of assets or equipment such as drilling rigs, pumps, and other equipment. In such instances, Scope 1 emissions may be understood as emissions that may be produced directly from the specific processes which are implemented, say during extraction of oil. Scope 2 emissions may be understood as emissions arising from generation of energy that may be procured by the oil industry. Other indirect sources of emissions arising from activities caused by the organization, in a value chain may be referred to as Scope 3 emissions.

Categorization into different sources also enables estimating the emission by any organization. As discussed previously, the quantity of emissions may be estimated based on the quantity of the goods that are to be produced, prospectively. Since the quantity of the goods to be manufactured and the quantity of emissions are correlated, one may estimate the emissions that may be produced pursuant to the production plan being implemented.

Although the present approach may be utilized for determining the net quantity of emissions that are likely to be produced once the production plan is implemented, such an approach does not provide any information as to the contribution of different stages that may be part of the underlying process. If the contribution of different stages cannot be determined, then no corrective or mitigative measures may be possible for reducing the net emissions. Recent legal frameworks, which impose constraints if certain committed emission thresholds are exceeded, are becoming prevalent and thus necessitate prospective estimation of emissions to account for any mitigative measures that may be implemented by the organization. Such norms now mandate that organizations set an emissions baseline and create targets for reducing emissions. The organizations may then track their progress towards achieving such emissions targets.

Accurate estimation of such targets may be managed in cases where the planned production remains uniform over a given period of time but may not be sufficient where the planned productions vary. If such variations are not taken into account, any estimation of emissions over an upcoming predefined time period may be inaccurate. For example, if an organization determines that its emissions produced for a coming time period is likely to exceed a committed threshold, it may undertake one or more measures so as to reduce the overall emissions.

Approaches for estimating emission intensity based on a proposed production plan are described. In an example, the emission intensity may be determined based on a weighted distribution of greenhouse gas emissions corresponding to an emission source. The emission source may either be a source of direct emissions (e.g., source of Scope 1 emission) or may be a source of indirect emissions (e.g., source of Scope 2/3 emission). In the present context, the direct sources of greenhouse gas emissions are defined under Scope 1 of the GHG protocol, while the indirect sources of greenhouse gas emissions, for example consumption of purchased electricity, heat or steam are defined under Scope 2 of the GHG protocol. The Scope 3 of the GHG protocol pertains to other indirect emissions such as the extraction and production of purchased materials and fuels, transport-related activities in vehicles not owned or controlled by an entity, and electricity-related activities not covered under Scope 2. Further, scope 3 emissions may also cover outsourced activities, waste disposal, etc. It is pertinent to note that the approaches for estimating emission intensity based on the proposed production plan covers emissions arising from all the scopes, as defined above, for example, scope 1, scope 2, and scope 3.

Emission source may further include a contributing category, with the contributing category further comprising a source level category. In an example, the weighted distribution may correspond to each of the contributing category and the source level category. In such a case, a first weighted distribution corresponding to a source level category indicates the contribution of greenhouse gas emissions by the source level category to the contributing category. In a similar manner, a second weighted distribution corresponding to the contributing category may depict the contribution of greenhouse gas emissions to the emission source.

It may be noted that the emission source may comprise multiple contributing categories, with each of the contributing categories comprising one or more source level categories. In such instances, the weighted distribution corresponding to the different source level categories of a given contributing category may depict the contribution of each of the different source level categories to the given contributing category. In a similar manner, a weighted distribution of different contributing categories may indicate the contribution of each of the different contributing categories to the total emissions that may be attributable to the emission intensity. In an example, the weighted distribution for each of the contributing categories and the source level categories may be based on historical emission data corresponding to the emission source implemented within an organization.

In an example, the contributing categories may refer to processes or stages within a process, for example, an industrial process. The source level categories on the other hand may refer to units, assets or components that may be emitting greenhouse gases during the course of implementing the industrial process (of which the units, assets, or components may be a part of). As may be understood, the weighted distribution values of the source level categories and in turn the contributing categories and the emission sources, may be used to depict a distributed and granular representation of emissions at different stages and at different levels of granularities. Although the present explanation has been provided in the context of one or more emission sources comprising one or more contributing categories, which in turn may further comprise one or more source level categories, the same is not to be considered as a limitation. In an example, further sub-categorizations of the source level categories or different categories within the emission source may be considered without deviating from the source of the present subject matter.

As may be understood, the weighted distributions provide a clear indication as to the extent of contribution by the different contributing categories and then further the source level categories, to the greenhouse gas emissions for a given emission source. The extent of contribution may be dependent on a variety of factors. The extent of contribution may depend on the industrial process (i.e., the contributing category). Some industrial processes may contribute comparatively less to the emissions as compared to other industrial processes.

It may be noted that the weighted distribution may be depicted in terms of the quantity of greenhouse gases that may be produced. In another example, the weighted distribution may also be depicted in terms of a percentage value to represent a percentage contribution of any one or more of the contributing categories or the source level categories towards the total emissions. It may be noted that the contribution of the contributing categories and the source level categories may depend on quantities or volume of goods manufactured within facilities of the organization. In an example, the emissions produced for industrial the volume or quantity of goods under consideration may be represented as emission intensity (i.e., volume of greenhouse gas emissions produced per net quantity of the goods manufactured).

Continuing with the present example, the various weighted distribution values corresponding to the contributing categories and the source level categories may then be utilized for estimating an emission intensity of an organization based on a received production plan. In an example, the received production plan may be based on orders that may be served upon the organization for completion. Based on the received production plan and the emission intensity (as determined above), a predicted emission quantity may be determined.

The predicted emission quantity thus determined (for the given production) may be then utilized for determining predicted emissions at the source level categories and the contributing categories. The predicted emissions at the source level categories and the contributing categories may be determined based on the weighted distribution values corresponding to each one of the source level categories and the contributing categories. In an example, the above-mentioned determination may be implemented by way of an emission estimation system. In an example, the emission estimation system may be implemented based on correlating values of the weighted distribution for each of the contributing categories and the source level categories with the quantities of goods that may have been manufactured. In another example, the emission estimation system may be implemented by way of a trained machine learning model. In such a case, the emission estimation system may be initially trained on a dataset comprising different emissions values that may be determined at the source level categories and the contributing categories and based on the corresponding production quantities that may have resulted in such emissions. Once trained, the emission estimation system may estimate emissions corresponding to quantities that may be required to be produced as part of a production plan.

As mentioned previously, the emission estimation system may process the production plan (provided as input) to determine the emissions that may be attributable to each of the contributing categories and the source level categories. It may be noted that the input provided to the emission estimation system may also comprise of a prospective production plan of any organization, for example, the prospective production details and/or source level distribution of resources associated with the organization which may render estimation of prediction of emissions in a more effective manner. As may be understood, the emission estimation system may provide a granular level of distribution of emissions for each of the source level categories and the contributing categories.

Although the above approaches have been described in the context of one or more processes implemented within an industrial facility, the same should not be construed as a limitation. Such approaches may be implemented in any facility where emissions are to be estimated. These implementations are only further examples of the claimed subject matter.

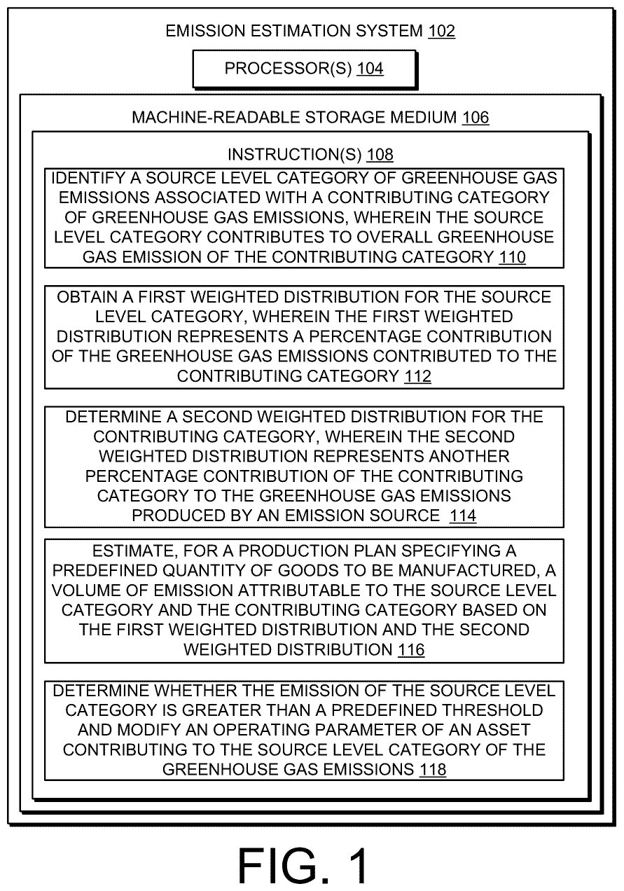

FIG. 1 illustrates an emission estimation system 102, also referred to as system 102 for estimating emissions produced from assets deployed in a facility, as per one example. The system 102, as will be explained further, may be associated with a facility within an organization. The facility may be carrying out a process, for example, a commercial or an industrial process for an organization, hospital, school, educational institutional, etc. The system 102 includes a processor 104 and a machine-readable storage medium 106 which is coupled to, and accessible by, the processor 104. System 102 may be implemented in any computing system, such as a storage array, server, desktop or a laptop computing device, a distributed computing system, or the like. Although not depicted, the system 102 may include other components, such as interfaces to communicate over the network or with external storage or computing devices, display, input/output interfaces, operating systems, applications, data, and other software or hardware components (all of which have not been depicted).

The processor 104 may be implemented as a dedicated processor, a shared processor, or a plurality of individual processors, some of which may be shared. The machine-readable storage medium 106 may be communicatively coupled to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 104 may fetch and execute instructions 108. In one example, as a result of the execution of the instructions 110, the system 102 may identify a source level category of greenhouse gas emissions. The source level categories may be related to emissions produced from units, assets or components being operated during the course of implementing the industrial process (of which the units, assets, or components may be a part of). The source level category is associated with a contributing category of greenhouse gas emissions. The source level category is such that it contributes to overall greenhouse gas emission of the contributing category. In an example, the contribution of greenhouse gas emissions of the source level category is related with an asset. Examples of an asset includes, but is not limited to, machinery, or equipment that may be used for implementing the process.

Returning to the present example, once the source level category is identified, the instructions 112 may be executed to obtain a first weighted distribution for the source level category. The first weighted distribution represents a percentage contribution of the greenhouse gas emissions contributed to the contributing category. The contributing category may pertain to the various stages of the industrial process being carried out in the facility of the organization. Once the first weighted distribution is obtained, the instructions 114 may be executed to determine a second weighted distribution for the contributing category. The second weighted distribution may represent another percentage contribution of the contributing category to the greenhouse gas emissions produced by an emission source. With the first weighted distribution and the second weighted distribution thus obtained, the instructions 116 may be executed to estimate a volume or quantity of emission attributable to the source level category and the contributing category based on the first weighted distribution and the second weighted distribution.

The estimation may be based on a production plan depicting a predefined quantity of goods to be manufactured by the organization. The process values corresponding to the volume estimated of emission attributable to the source level category and the contributing category, may provide segregated values for different organizational level of an organization implementing an industrial process for production of goods. Once the estimation is completed, instructions 118 may be executed to determine whether the emission of the source level category is greater than a first predefined threshold. If the source level category is greater than the first predefined threshold, an alert may be generated for modifying an operating parameter of the asset contributing to the source level category of greenhouse gas emissions. For example, the operating parameter may be one of a temperature, pressure, duty cycle, and load capacity of the asset operating during industrial process. However, there may be various other operating parameters that may be monitored during the ongoing industrial process, without deviating from the scope of the present subject matter.

In an example, the indication may be in the form of a visual or an audio alert generated through pertinent output devices coupled with the system 102. Examples of such an operating parameter includes, but is not limited to, supplementing the process with additional measures or deploying additional equipment or components to treat the emissions for reducing the quantity of the greenhouse gases therein. In another example, when the first predefined threshold is exceeded, the instructions 108 may be executed to generate an alert for a given asset. The alert may be depicted by way of a visual indication a dashboard.

The above functionalities performed as a result of the execution of the instructions 108, may be performed by different programmable entities. Such programmable entities may be implemented through any computing systems, which may be implemented either on a single computing device, or multiple computing devices. As will be explained, various examples of the present subject matter are described in the context of a computing system which estimate a volume of emission attributable to the source level category and the contributing category, with respect to the industrial process being carried out in the facility of the organization. These and other examples are further described with respect to the remaining figures.

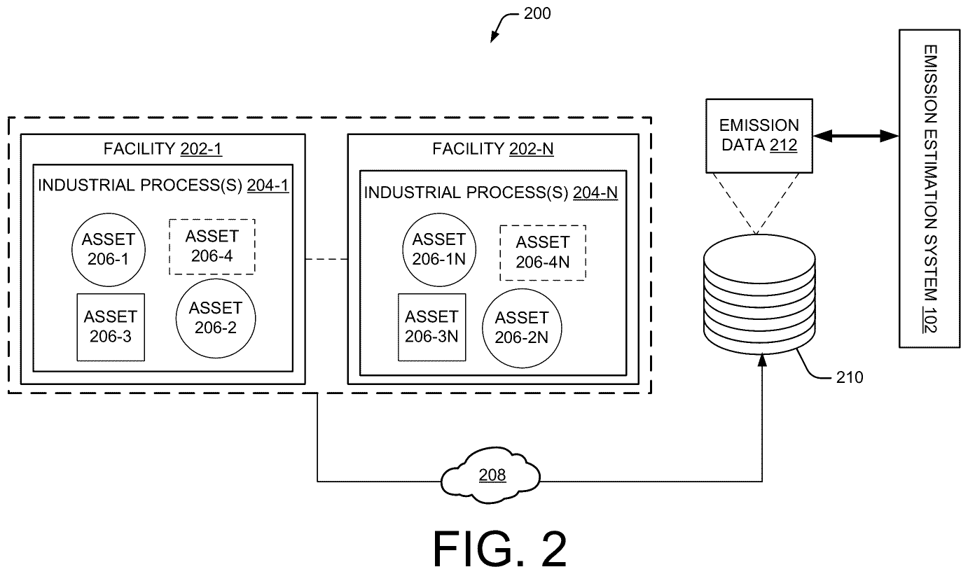

FIG. 2 illustrates an environment 200 corresponding to an organization. The environment 200 further comprises facility 202-1, . . . , N (collectively referred to as facilities 202). Each of the facilities 202 may implement one or more processes, for example, an industrial processes 204-1, 204-2, . . . , 204-N (collectively referred to as processes 204). A process is to achieve a process objective or an end result. Examples of a process objective includes, but is not limited to, a product which is manufactured, services rendered, information processed, or any other activity that may be performed for accomplishing predefined functional or operational tasks within an organization. The process objectives or end results may correspond to the industry to which the organization may pertain to.

For example, if the organization is engaged in the process of oil extraction, then any one of the facilities 202 (say facility 202-1) may implement processes 204 for the extraction, purification, and such other processes. Other examples of industry to which any given organization may pertain to, include but are not limited to, a warehouse in a packaging industry, an automobile manufacturing facility, a consumer-goods manufacturing facility, an e-commerce storage unit, a cold storage facility, a pharmaceutical manufacturing unit, a distributer of a logistics company, and the like. It may be noted that the present set of examples are only indicative are not to be construed as limiting the scope of the claimed subject matter in any manner.

Returning to the example as illustrated in FIG. 2, The processes 204 may be implemented through one or more assets. For example, facility 202-1 may include multiple asset(s) 206-1, 2, 3, and 4 (collectively referred to as asset(s) 206). In a similar manner, other facilities 202, say the facility 202-N, may further comprise their asset(s) 206-1N, . . . , 4N. As may be understood, the operation of the asset(s) 206 may, over a period of time, produce gaseous emissions which may comprise one or more types of greenhouse gases. Assets may include any machinery, vehicles, or equipment that is used in a commercial or industrial facility or organization.

Although not depicted in FIG. 2, one or more sensors may be installed in each of the asset(s) 206. The sensors, besides monitoring various operational parameters of the assets, may monitor and measure the volume of the greenhouse gas emissions that may be produced by each of the asset(s) 206. For example, if asset is a conduit for carrying oil (or any other fluid), the sensors may monitor and determine fill level, flow rate, pressure, and/or temperature sensors. The data obtained from the sensors may thereafter be communicated via a network 208 to a data repository 210, where it may be stored as emission data 212.

In an example, the network 208 may be a wireless network or a combination of a wired and wireless network. The network 208 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description.

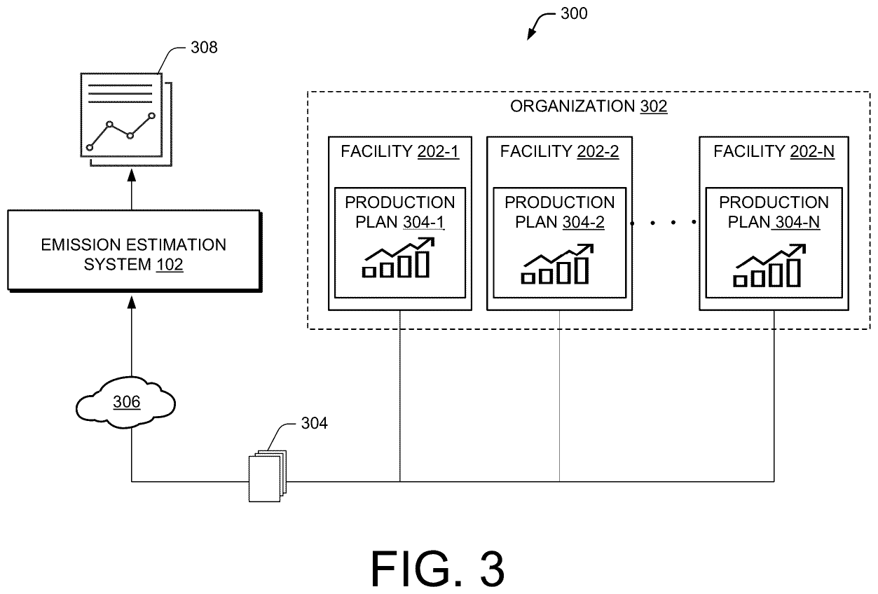

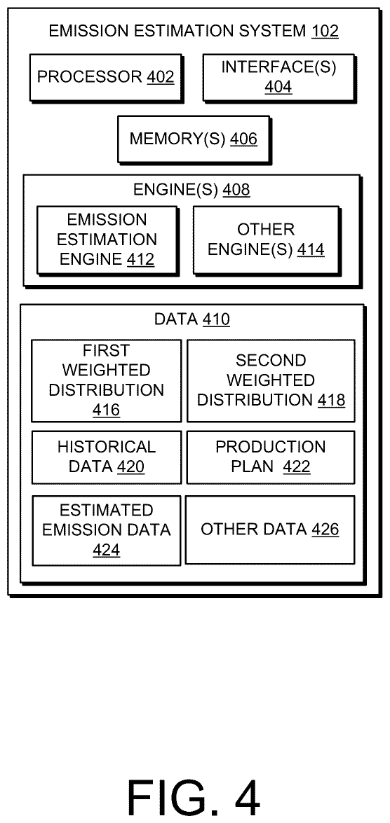

The emission data 212 thereafter may be retrieved by the emission estimation system 102 (referred to as the system 102). As will be explained further, the system 102 may thereafter be configured based on the emission data 212, for estimating emissions based on a proposed production plan. The estimated emissions may thereafter be considered for implementing one or more measures for reducing the estimated emissions that are likely to result once production as per the production plan is completed. The manner in which the emissions may be estimated is further discussed in relation to FIGS. 3-4.

FIG. 3 illustrates another environment 300 wherein which, based on a production plan, the system 102 may estimate emissions for the facilities 202 (and thus an organization as a whole). The environment 300 comprises an organization 302. The organization 302 may be engaged in manufacturing of goods. For manufacturing, the organization 302 may implement one or more processes, such as processes 204, that may be implemented across any one or more facilities 202.

As discussed above, each facility 202 may operate depending on the production objectives as defined in a production plan. Manufacturing facilities within an organization may plan their operations based on a production plan. For example, the production plan may specify the quantity of certain goods that are to be manufactured by any one or more facilities 202, over a period of time. Each of the facilities 202 may generate emissions comprising greenhouse gases during the course of production. In an example, the emissions that are likely to be produced may be estimated by the system 102, based on the received production plan. The estimated emissions thus obtained providing granular information identifying the contribution of source level category (i.e., at the level of the asset(s) 206) and the contributing category

In an example, the facilities 202 of the organization 302 may receive one or more production plan(s) 304-1, 2, . . . , N (collectively referred to as the production plan(s) 304). Once received, the production plan(s) 304 may be communicated through the network 306 to the emission estimation system 102. The system 102 once receiving the production plan(s) 304 may process the same to estimate emissions that may be produced by the facilities 202 within the organization 302, during the course of production as per the production plan(s) 304. The emission estimates may be captured and presented within an emission report 308. In an example, the emission estimates provided by the system 102 may provide contribution to the total emissions by the contributing category and the source level category. In an example, the extent of contribution may be indicated as first weighted distribution and a second weighted distribution. These and other details are further discussed in conjunction with FIG. 4.

FIG. 4 illustrates one or more functional blocks of the system 102, as per an example. The system 102 includes a processor 402, interface(s) 404, and memory(s) 406. The processor 402 may be implemented as microprocessors, microcomputers, microcontrollers, digital signal processors, central processing units, state machines, logic circuitries, and/or other devices that manipulate signals based on operational instructions. The interface(s) 404 may allow the connection or coupling of the system 102 with one or more other devices, through a wired (e.g., Local Area Network, i.e., LAN) connection or through a wireless connection (e.g., Bluetooth®, Wi-Fi). The interface(s) 404 may also enable intercommunication between different logical as well as hardware components of the system 102. The interface(s) 404 may also enable the system 102 to communicate with other entities, such as the data repository 210, or other devices or systems (not shown in the figures) which may be present within the facilities 202.

The memory(s) 406 may be a computer-readable medium, examples of which include volatile memory (e.g., RAM), and/or non-volatile memory (e.g., Erasable Programmable read-only memory, i.e., EPROM, flash memory, etc.). The memory(s) 406 may be an external memory, or internal memory, such as a flash drive, a compact disk drive, an external hard disk drive, or the like. The memory(s) 406 may further include data which either may be utilized or generated during the operation of the system 102.

The system 102 may further include engine(s) 408 and data 410. The engine(s) 408 may be implemented as a combination of hardware and programming, for example, programmable instructions to implement a variety of functionalities of the engine(s) 408. In examples described herein, such combinations of hardware and programming may be implemented in several different ways. For example, the programming for the engine(s) 408 may be executable instructions. Such instructions may be stored on a non-transitory machine-readable storage medium which may be coupled either directly with the system 102 or indirectly (for example, through networked means). In an example, the engine(s) 408 may include a processing resource, for example, either a single processor or a combination of multiple processors, to execute such instructions. In the present examples, the non-transitory machine-readable storage medium may store instructions that, when executed by the processing resource, implement engine(s) 408. In other examples, the engine(s) 408 may be implemented as electronic circuitry. In one example, the engine(s) 408 may be implemented through a machine-learning model that implements machine-learning techniques, statistical techniques, or probabilistic techniques. Examples of such techniques may include expert systems, support vector machines (SVM), neural networks, or the like.

The engine(s) 408 includes an emission estimation engine 412, and other engine(s) 414. The other engine(s) 414 may further implement functionalities that supplement functions performed by the system 102 or any of the engine(s) 408. The data 410, on the other hand, includes data that is either stored or generated as a result of functions implemented by any of the engine(s) 408 or the system 102. It may be further noted that information stored and available in data 410 may be utilized by the engine(s) 408 for performing various functions to be implemented by the system 102. In an example, data 410 may include a first weighted distribution 416, a second weighted distribution 418, historical data 420, production plan(s) 422, estimated emission data 424, and other data 426. It may be noted that such examples of the various functional blocks as depicted in FIG. 4 are indicative. The present approaches may be applicable to other examples without deviating from the scope of the present subject matter.

The operation of the system 102 is explained in conjunction with the environments 200 and 300, as depicted in FIGS. 2-3. The system 102 may initially retrieve emission data 212 from the data repository 210. As explained in relation to FIG. 2, the emission data 212 is collected from one or more sensors of the asset(s) 206 and stored in the data repository 210. The emission data 212 may alternatively be stored within the memory(s) 406 of the system 102, without deviating from the scope of the claimed subject matter. The emission data 212 may be retrieved in response to a command, or the system 102 may be configured to retrieve the emission data 212 from the data repository at predefined intervals or specified time instants.

The emission data 212 once retrieved by the system 102, may be processed and analysed by the emission estimation engine 412 to determine a first weighted distribution 416 and a second weighted distribution 418. As described earlier, each of the asset(s) 206 may be associated with one or more sensors. The sensors may monitor and determine the quantity of the emissions that may be produced by the asset(s) 206. The asset-specific emission data once generated, may be tagged with one or more identifiers, which are to indicate the asset (from amongst the asset(s) 206) to which the emission data corresponds with. For example, an identifier corresponding to the asset 206-1 may be associated with the emission data that has been obtained from asset 206-1, before it is recorded in the data repository 210. In an example, the identifier may be determined and associated by an instruction-based system that may be in communication with the sensor of the asset 206-1. In a similar manner, the emission data from the other asset(s) of asset(s) 206 may be determined and associated with the appropriate identifiers. Once the identifier is tagged with the emission data, the same may be transmitted from the asset(s) 206 by the instruction-based system to the data repository and stored as emission data 212.

The emission data 212 thus includes data pertaining to the volume of the emissions produced by each of the asset(s) 206 (as denoted by the corresponding identifier). Since the emission information within the emission data 212 is linked to each of the asset(s) 206, the emission data 212 thus includes, at a granular level, asset-specific contribution of each of the asset(s) 206 to the total emissions by the organization 302. In an example, the emission data 212 may be correlated with a production objective. The production objective may specify the quantity of goods that may have been produced or manufactured using or involving the asset(s) 206. It is these goods, the manufacturing of which would have resulted in the emissions recorded as emission data 212.

Once the emission data 212 is collected, the emission estimation engine 412 may process the same to determine the emissions by the asset(s) 206 at the source level (i.e., the source level contribution) as well as at the category level. Source level contribution, in the context of the present subject matter, may refer to the contribution of a given emission source (for example, any one of the asset(s) 206) to the overall emissions of a certain category. Within an organization, multiple such categories may exist. Examples of such other multiple categories include, but are not limited to, combustion, flaring, and fugitive emissions (in the context of oil and natural gas processing).

In case of ‘storage tank flashing’, asset(s) 206 which may be involved therein would be considered sources of emissions. These sources, as may be understood, would contribute to a contributing category (which in the present example, is ‘venting’). In a similar manner, other sources (i.e., other asset(s) 206) each may be contributing to different contributing categories within the organization 302. The overall emissions aggregated across all contributing categories would represent the total emissions of the organization 302. Since each of the asset(s) 206 are associated or identifiable through an identifier, and each asset(s) 206 correspond to a contributing category, emission information for different contributing categories may be determined based on the emission data 212 of each of the asset(s) 206.

The above is explained in the context of asset 206-1 involved in process of ‘storage tank flashing’, with the ‘storage tank flashing’ being a process which contributes to the stage ‘venting’. In a similar manner, a first set of asset(s) 206 may be involved in other processes, such as ‘vessel blowdowns’, ‘dehydrator’, and ‘pneumatic devices’, each of which may be contributing to the emissions of the stage, ‘venting’. In a similar manner, further other sets of asset(s) 206 may be involved for different processes, each of which may be contributing to the emission of other stages, such as ‘combustion’, ‘flaring’, and ‘fugitive emission’. It is pertinent to note that the present example processes and stages are provided for explanation only. Although the above examples are pertinent to the process of oil refining and manufacturing, the same should not be considered as a limitation. The present approaches may also be implemented for other processes directed towards or in relation to manufacturing, production, assembling, or other processes which may, either directly or indirectly, result in a finished product or goods, and in applicable cases, services.

The emissions at the source level as well as at the contributing category level may thereafter be determined by the emission estimation engine 412. In an example, the emission estimation engine 412 may identify the asset(s) 206 from which the emission data 212 has been collected, based on the respective identifier. In an example, the emission data 212 may be stored as historical data 420. The emission estimation engine 412 may retrieve the information pertaining to the emissions either as emission data 212 from the data repository 210 or from the historical data 420, without deviating from the scope of the present subject matter.

Once identified, the emission estimation engine 412 may categorize one or more portions of the emission data 212 (or the historical data 420, as the case may be) for each of the different contributing categories, based on the asset(s) 206. For example, the portion of the emission data 212 which corresponds to say asset 206-1, which is involved for ‘storage tank flashing’, would be apportioned and attributed to the contributing category, ‘venting’. In a similar manner, the portion of the emission data 212 for asset(s) 206-2, and 3, which may be involved in other processes such as ‘vessel blowdowns’, may also be apportioned and attributed to the contributing category, ‘venting’. In a similar manner, such portions of the emission data 212 which are attributable to the most granular source of emission, i.e., the asset(s) 206, may be ‘rolled up’, i.e., their contribution considered and attributed to the contributing category, to which the asset(s) 206 may be a part of.

Based on the emission contribution of the asset(s) 206 and emission contribution arising from the corresponding contributing category, the emission estimation engine 412 may determine respective values for the first weighted distribution 416 and the second weighted distribution 418, respectively. For example, the asset (say asset 206-1) that may be involved in the process of ‘storage tank flashing’ as part of the overall ‘venting’ process. In a similar manner, other asset(s) 206 (e.g., asset 206-2, 206-3, and so on), may be involved or be related to ‘vessel blowdowns’, ‘dehydrator’, ‘pneumatic devices’, and such other sources level categories. Based on the proportion of the emission data 212 attributable to the asset 206-1 (i.e., for the ‘storage tank flashing’) to the stage, ‘venting’ (which is the contributing category), the emission estimation engine 412 may determine a percentage contribution of the asset 206-1 (i.e., the source level category) to ‘venting’ (i.e., the contributing category). In a similar manner, a percentage contribution may be determined for all the asset(s) 206 at the source level category. Once determined, the first weighted distribution 416 depicting percentage contribution of the source level category (i.e., the asset(s) 206) to the emissions of the contributing category may be stored within the system 102. As may be understood, a high value of the first weighted distribution 416 may depict that the asset, e.g., the asset 206-1, is a prominent contributor of emissions within the contributing category. A low value of the first weighted distribution 416 may depict that any one of the asset(s) 206, may not be a prominent source of emissions within the contributing category.

Once the first weighted distribution 416 is determined, the emission estimation engine 412, based on the volume of emissions attributed to each of the contributing category, may determine the second weighted distribution 418 which depicts a percentage or proportion of the emissions of the contributing category to the overall emissions. The overall emissions may be produced by an emission source, which may be one of a direct emission source (e.g., as defined under Scope 1 emission of the greenhouse gas protocol) or an indirect emission source (e.g., as defined under Scope 2/3 of the greenhouse gas protocol). Similar to the first weighted distribution 416, a higher value of the second weighted distribution 418 implies that the contributing category (for which the value of the second weighted distribution 418 was higher) is a prominent contributor to the emissions (either one of Scope 1, 2, or 3).

In an example, the first weighted distribution 416 and the second weighted distribution 418 may be correlated with the quantity of goods being manufactured. The goods being referred to includes multiple units of an article or a product, the manufacturing of which have resulted in the emissions as represented by the emission data 212. In an example, instead of the quantity of emissions produced by the source level category, the emission data 212 may also depict emission intensity. Emission intensity, in an example, may refer to the quantity of greenhouse gases released per metric of an operation. The metric of the operation may represent quantity or units of goods being manufactured. Once the first weighted distribution 416 and the second weighted distribution 418 are determined, the same may be used as a basis for distributing the emission intensity value, corresponding to given quantity of product, across the source level category as well as the contributing category. Such a distribution would yet again depict the contribution of the source level category and the contributing category to the emission intensity.

As may be understood, the historical data 420 (consisting of the emission data 212) may depict the variation of the emissions with varying previous or historical production undertaken by the organization 302. In such instances, a machine-learning model may also be trained based on the emission data 212. As explained previously, the emission data 212 comprises the source level as well as the category level contributions to the total emissions of the organization 302 for a definite time period (i.e., the time period during which the production as per the historical production plan may have taken place). Based on the emission data 212, the trained machine-learning model may be able to establish a correlation between the emission data 212 corresponding to the source as well as the category across the organization 302 for a corresponding product. In a similar manner, the machine-learning model may be trained based on the historical data 420 or the emission data 212 for a plurality of such production plans. The plurality of production plans may correspond to either a single type of article or goods, or may correspond to different articles or goods, without deviating from the scope of the present subject matter. Once trained, the machine-learning model may be used for estimating emission intensity based on a received production plan. These and other approaches may be adopted for configuring the system 102 for estimating the emission intensity based on a proposed production plan.

In an example, the system 102 may estimate the emission intensity in response to receiving production plan in real-time, based on the estimated first weighted distribution 416 and the second weighted distribution 418. As described previously, the production plan may specify the quantity of goods or articles that are to be manufactured by the facilities 202 of the organization 302. In an example, the production plan may be stored as production plan 422 within the system 102. The production plan 422 may be provided as information in a predefined format or schema, specifying, amongst other things, the quantity of certain goods to be manufactured or produced by the facilities 202 of the organization 302. In the context of the examples described previously, the production plan 422 may specify volume of oil that may have to be refined using any one or more of the facilities 202 for a predefined upcoming period. It may be noted that the production plan 422 thus received by the organization may be over and above the planned production that the organization 302 may have scheduled and planned for, say for the upcoming year. This would include factoring the GHG emissions that may be produced as a result of undertaking the planned production. Now undertaking production as per the production plan 422 would result in exceeding the emissions estimates that may have been made prior to receiving the production plan 422.

Returning to the present example, once received, the emission estimation engine 412 may process the received production plan 422 to determine the goods and the quantity of goods that have to be manufactured. As the quantity of any given goods are correlated with the estimated emission data 424 that may be produced by the organization 302, the emission estimation engine 412 based on the quantity of the goods indicated in the production plan 422, may estimate the estimated emission data 424 that would be generated if the production plan 422 is implemented.

Once the estimated emission data 424 is determined, the emission estimation engine 412 may retrieve the first weighted distribution 416 and the second weighted distribution 418. As explained above, the first weighted distribution 416 and the second weighted distribution 418 are values which depict the percentage contribution of the asset(s) 206 to the contributing category, and the percentage contribution of the contributing category to the emission source. Having obtained the estimated total emissions (that were determined based on the production plan), the emission estimation engine 412, using the first weighted distribution 416 and the second weighted distribution 418, determines the estimate emissions at the source level, i.e., for the asset(s) 206, as well as for the contributing categories for the organization 302. The estimate emissions determined based on the first weighted distribution 416 and the second weighted distribution 418 thus provide a granular level estimation of the contribution not only at the level of the asset(s) 206, but also at the level of the each of the contributing categories, to which the asset(s) 206 may pertain to.

The above aspects are explained in relation to certain examples involving the contributing category, ‘venting’, which may include processes such as ‘storage tank flashing’, ‘vessel blowdowns’, ‘dehydrator’, ‘pneumatic devices’, and such other sources level categories, being implemented for a set of asset(s) 206. As explained previously with respect to an example, based on the emission data 212, the first weighted distribution 416 and second weighted distribution 418 that were determined for asset(s) 206-1, 2 and 3:

| Name of Asset | Weighted Contribution to ‘venting’ |
|---|---|
| Asset 206-1 | 60% |
| Asset 206-2 | 30% |
| Asset 206-3 | 10% |

In a similar manner, other asset(s) 206 may be involved for other processes ‘vessel blowdowns’, ‘dehydrator’, and/or ‘pneumatic devices’, without deviating from the scope of the present subject matter. The contribution of the contributing category ‘venting’, along with other exemplary contributing categories is provided below (based on the values determined in the previous examples):

| | Contribution to the Emission |
|---|---|
| Name of Asset | Source (e.g., Scope 1) |
| Venting | 40% |
| Combustion | 30% |
| Flaring | 20% |
| Fugitive Emission | 10% |

The former table above indicates the different values of the first weighted distribution 416 attributed to the indicated asset(s) 206, whereas the latter table indicates the second weighted distribution 418 for the different contributing categories, namely, ‘venting’, ‘combustion’, ‘flaring’, and/or ‘fugitive emission’. Based on the above first weighted distribution 416 and the second weighted distribution 418, and based on the estimated emission data 424, the emission estimation engine 412 may further determine the emissions that are like to results from each of the asset(s) 206 and for each of the contributing categories. For example, if the value of the estimated emission data 424 is 100 tonnes of CO₂ that are likely to be produced upon completion of the production plan 422, then the corresponding values for each of the contributing categories, and then values correspondingly ‘rolled down’ to the asset(s) 206 (i.e., the source level) may be determined. The following table provides corresponding emissions that may be attributed to each of the listed contributing categories:

| | Contribution to the | Estimated Emission attributable |
|---|---|---|
| Name of Asset | Emission Source | to current contributing category |
| Venting | 40% | 40 Tonnes |
| Combustion | 30% | 30 Tonnes |
| Flaring | 20% | 20 Tonnes |
| Fugitive | 10% | 10 Tonnes |
| Emission | | |

As may be observed from above, the stage ‘venting’ is estimated to produce 40 Tonnes of CO₂ if the production plan 422 is completed. With the above estimated emission for ‘venting’, the corresponding emissions for each of the asset(s) 206 that may be involved in the stage ‘venting’, may be determined. In such instances, the estimated emissions for the asset 206-1 would be based on the estimated emissions determined for the stage, ‘venting’ and the first weighted distribution 416 corresponding to the asset 206-1. In the same manner, the estimated emissions for the other assets 206-2 and 202-3, may be determined based on their corresponding values of first weighted distribution 416. The following table provides an exemplary value of the estimated emissions for each of the asset(s) 206-1, 2 and 3:

| | Weighted | Estimated | |
|---|---|---|---|
| Name of | Contribution to | Emission | Estimated |
| Asset | ‘venting’ | for ‘Venting’ | emission data |
| Asset 206-1 | 60% | 40 Tonnes | 24 Tones |
| Asset 206-2 | 30% | 40 Tonnes | 12 Tonnes |
| Asset 206-3 | 10% | 40 Tonnes | 4 Tonnes |

As depicted in the table below, the emission estimation engine 412 determines the estimated emissions that are likely to be produced by each of the respect asset(s) 206, i.e., asset 206-1, 2 and 3, at a granular level. The emission estimation engine 412 additionally also determines the net emissions that may be produced if the production as per the received production plan 422 is completed. In this manner, the system 102 is to determine the emissions estimates for not only the asset(s) 206 but also for each of the contributing categories, as described in the examples above. It is pertinent to note that the above examples have been described in the context an example production plan 422 pertaining to refining of oil. It may be noted that the above approaches are applicable for any other organizations or facilities that may be engaged in activities pertaining to other types of products. In instances where any organization 302 is producing multiple types of products, the above approaches are capable of providing estimated emissions for asset(s) 206 and/or the corresponding contributing category which may be involved in the manufacturing of such products.

The estimated emissions may be thereafter stored in the estimated emission data 424, with each estimated emission being tagged with an identifier indicating the asset(s) 206 to which the estimates pertain to. In a similar manner, the estimated emission data 424 may also store the estimates for each of the contributing categories as well. The estimated emission data 424 may represent the estimates, over and above what the organization 302 may have factored for a defined time period (say a given financial or calendar year). In an example, the emission estimation engine 412 may determine the total emissions estimates (i.e., the sum of prior emission estimates as well as the estimated emission data 424) to determine whether the organization 302 is to exceed committed emission thresholds. To this end, the emission estimation engine 412 may compare the total emission estimates with a predefined threshold. The predefined threshold, in an example, may correspond to the committed emissions that may have been submitted (say as part of regulatory compliance or prevailing regulations). Based on the comparison, the emission estimation engine 412 may generate an indication corresponding to the relative status of the total emissions that are likely to be produced by the organization 302. For example, if the total emission estimates are less than the predefined threshold, the emission estimation engine 412 may generate an indication which reflects a deficit value, which is the difference between the total emission estimates and the predefined threshold.

As may be understood, the deficit value (which in turn reflects the reduction in the emissions) may be availed by the organization 302. For example, the deficit value determined may be reported to the appropriate regulatory authorities for evaluation. In an example, the deficit value may also be used by the organization 302 for claiming one or more tax benefits under prevailing legislations. In another example, the deficit value may be used to offset any prospective emissions that may be generated by the organization 302 or may be used as basis for securing negotiable or tradable instruments. Such uses of the deficit value are only indicative examples and should not be construed as limiting the scope of the claimed subject matter in any way.

It may also be the case that the total emission estimates are greater than the predefined threshold. In such a case, the emission estimation engine 412 may generate a visual or audio alert to indicate that the total emission estimates, if the production plan 422 is completed, are likely to exceed the committed emissions as may have been submitted by the organization 302, say as part of the regulatory compliances. The extent by which the total emission estimates exceed the predefined threshold may be used as an indication by the organization 302 to decide the appropriate measures, e.g., securing credits from other parties, etc., that may have to be secured to offset the deviation from the predefined threshold.

It may be noted that the organization 302 may adopt certain technical measures in response to detecting that the total emission estimates are greater than the predefined threshold. In an example, on detecting that the total emission estimates are greater than the predefined threshold the emission estimation engine 412 may retrieve the estimated emission data 424 for each of the asset(s) 206. Once retrieved, the estimated emission data 424 may be compared with a second predefined threshold which may be associated for each of the asset(s) 206.

Based on the comparison, the emission estimation engine 412 may identify asset(s) 206 for which the estimated emission data 424 is greater than the second predefined threshold. For example, the emission estimation engine 412 may determine that the estimated emissions for asset 206-1 may be greater than the second predefined threshold associated with it. The emission estimation engine 412 in response to such a determination may provide an indication that the asset 206-1 is likely to exceed its associated threshold attributed, and recommend compensatory control measures, respective to modifying operating parameters of the asset(s) 206. For example, the operating parameter may be one of a temperature, pressure, duty cycle, and load capacity of the asset operating during industrial process.

In response to the indication provided, the emission estimation engine 412 may determine whether any operating parameter of the asset(s) 206, i.e., the asset 206-1, has to be modified or corrected to enable reducing the estimated emissions. The change in operating parameter may include changing the manner in which the asset 206-1 is controlled or operated. For example, the emission estimation engine 412 may cause the asset 206-1 to power down when not used for certain periods of time. In another example, the emission estimation engine 412 may also recommend supplementing the asset 206-1 with components that may cause reduction in the emission estimates. The recommendations provided by the emission estimation engine 412 may be based on previously prescribed suggestive actions that may be undertaken. In the context of ‘venting’, the emission estimation engine 412 may recommend replacing the filters of the asset 206-1 with advanced or different category of filters which are capable of reducing the amount of greenhouse gases in the emissions that are being produced. In addition, the emission estimation engine 412 may also recommend one or more corrective maintenance procedures to be performed which are like to reduce the emissions that may be generated for the asset 206-1.

It is pertinent to note that the above examples, although provided in relation to asset 206-1, are only exemplary. The approaches discussed in relation to such examples are applicable for any one or more of the asset(s) 206 without deviating from the scope of the present subject matter. Furthermore, the corrective measures or recommendation are only few of the changes in the operation parameter of the asset 206-1, that may be affected by the emission estimation engine 412, without limiting the scope of the claimed subject matter.

Although, the present approaches have been described for direct sources of emission (defined under scope 1 of the GHG protocol), the same may be extended to indirect sources of emission (defined under scope 2 and scope 3 of the GHG protocol), without deviating from the scope of present subject matter. For instance, the present approaches may also be applicable to indirect sources of emissions encompassing upstream processes (which involve use of raw materials) and downstream processes (which may result in finished products in parts or as a whole) within any given supply chain. In a similar manner, the emissions arising as a result of indirect sources of emissions may also be categorized into one of source level categories and contributing categories, based on examples of the present subject matter. Such emissions (arising as a result of indirect sources) may be retrieved and processed, as per the present examples, to further obtain a volume of emission attributable to the source level category and the contributing category, without deviating from the scope of present subject matter.

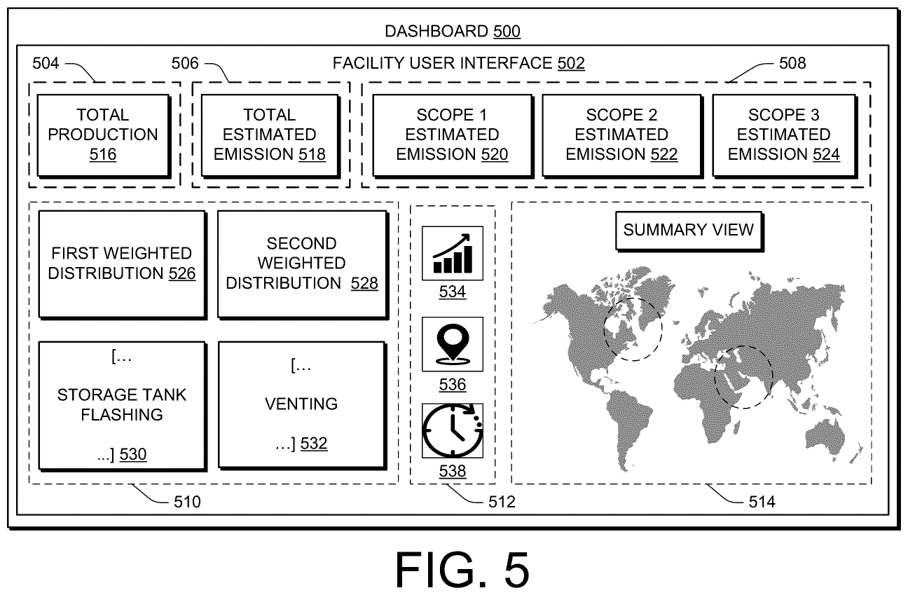

Returning to the present example, the emission estimation engine 412 generates a dashboard 500 of a facility user interface 502 which is displayed on an output device coupled to the device. An example dashboard 500 is depicted in FIG. 5. The dashboard 500 comprises one or more informational sections and sub-sections. The informational sections are to provide information pertaining to different data elements as discussed in conjunction with the preceding figures. The facility user interface 502 may include a visual representation or various blocks representing a total production section 504, a total estimated emission section 506, and a distribution of emissions section 508. The total production section 504 may be representative of a total production 516 of goods produced in facility 202 based on implementation of the industrial processes 204. The total estimated emission section 506 may be based on a total emission 518 totaled across all categories, for example, the source level categories and the contributing categories, with respect to the total production 516 or volume of goods produced within the facility 202.

Further, the distribution of emissions section 508 may be representative of a distribution of total estimated emissions 518 across Scope 1, Scope 2, and Scope 3 emissions related to various sources of emissions, for example, direct and indirect sources of emissions. The Scope 1 estimated emissions 520 pertain to the direct sources of GHG emissions as defined under Scope 1 of the GHG protocol, while the Scope 2 and Scope 3 estimated emissions pertain to the indirect sources of greenhouse gas emissions, as defined under the GHG protocol. The distribution of emissions section 508 displaying the Scope 1 estimation 520, Scope 2 estimated emission 522, and Scope 3 estimated emission 524 enables one to estimate emission that may be related to the different sources of emissions and may help the organization 302 to take an appropriate action to reduce emissions.

Continuing further, the facility user interface 502 may comprise a weighted distribution section, referred to as section 510, representing a first weighted distribution 526 and a second weighted distribution 528. The first weighted distribution 526 corresponds to a source level category and is indicative of the contribution of greenhouse gas emissions by the source level category to a contributing category. In a similar manner, a second weighted distribution 528 corresponds to the contributing category and may depict the contribution of greenhouse gas emissions to the emission source, for example, the direct emission source and the indirect emission source (defined under Scope 1, Scope 2, and Scope 3 of the GHG Protocol).

The first weighted distribution 526 may be tagged to their asset 206-1 (i.e., for the ‘storage tank flashing’), represented by numeral ‘530’ and the second weighted distribution 528 may be tagged to their respective stage, ‘venting’ (which is the contributing category), represented by numeral ‘532’. Such a percentage contribution may be determined for all the asset(s) 206 and may be represented as the first weighted distribution 526. The first weighted distribution 526, as may be noted, depicts the percentage contribution of the source level category (i.e., the asset(s) 206) to the emissions of the contributing category. A high value of the first weighted distribution 526 may depict that the asset under consideration, say the asset 206-1, is a prominent source of emissions within the contributing category. As a corollary, a low value of the first weighted distribution 526 may depict that the underlying asset, from amongst the asset(s) 206, may not be a prominent source of emissions within the contributing category.

The second weighted distribution 528 may represent the percentage contribution of the contributing category to an emission source. In an example, the emission source may be one of a direct emission source (e.g., as defined under Scope 1 emission of the greenhouse gas protocol) or an indirect emission source (e.g., as defined under Scope 2/3 of the greenhouse gas protocol). A higher value of the second weighted distribution 528 would in turn depict that the contributing category (for which the value of the second weighted distribution 528 was higher) is a prominent contributor to the emissions (either one of Scope 1, 2, or 3).

The facility user interface 502 may also comprise of a widget section 512 having multiple selectable options for selecting, for example, but not limited to, a trend and/or pattern of emissions relative to a region for a particular time interval. For example, section 514 may be displayed upon selection of one of the widget options depicted in section 512. In one example, a user operating the dashboard 500 may wish to find out a percentage contribution related to ‘storage tank flashing’, for a period of, say three months, say January till March, for a given region.

The user may select widget 538 representative of the time period of January till March, and widget 536 for selecting a particular region or production site (which may be the facility 202 or the organization 302). Upon such a command by the user, one or more computer generated instructions may cause the dashboard to depict an instance representative of a total production 516 of goods produced, a total estimated emissions 518, a distribution of total emissions under Scope 1, Scope 2, and Scope 3 (520, 522, and 524, respectively), a first weighted distribution 526, a second weighted distribution 528, for January till March. The widget 534 may be selected to represent a trend and/or pattern pertaining to the first weighted distribution 526 and second weighted distribution 528, respectively, which may be shown in the section 514. It may be noted that although the present example facility user interface 502 is shown as displaying section(s) 504, 506, 508, 510, 512, and 514 of a given instance, the facility user interface 502 may depict multiple other instances without deviating from the scope of the present subject matter. Such examples would also fall within the scope of the present subject matter.

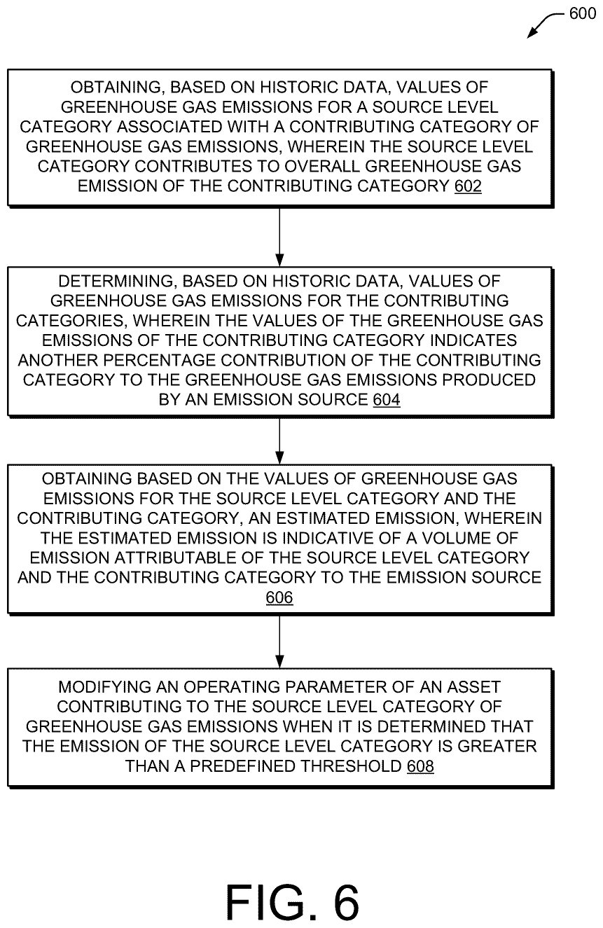

FIG. 6 illustrates a method for estimation of greenhouse gas emissions in a facility, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by an emission estimation system, such as emission estimation system 102. In an implementation, the method may be performed under an “as a service” delivery model, where the emission estimation system 102, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 600 may be implemented by the emission estimation system 102 for estimation of greenhouse gas emissions based on a production plan. To this end, at block 602, based on historic data, values of greenhouse gas emissions for a source level category associated with a contributing category may be obtained. The source level categories may be related to emissions produced from units, assets or components being operated during the course of implementing the industrial process (of which the units, assets, or components may be a part of). The source level category is such that it contributes to overall greenhouse gas emission of the contributing category. In an example, the contribution of greenhouse gas emissions of the source level category is related with an asset. Examples of an asset includes, but is not limited to, machinery, or equipment that may be used for implementing the process. In an example, the source level category contributes to overall emissions of the contributing category. The values of the greenhouse gas emissions of the source level category may indicate a percentage contribution of greenhouse gas emissions contributed to the contributing category. The percentage contribution of greenhouse gas emissions contributed by the source level category may be referred to as a first weighted distribution.

At block 604, values of greenhouse gas emissions for the contributing category may be determined. For example, once the values of greenhouse gas emissions for the source level category are obtained, the system 102 may obtain another percentage contribution of the contributing category. The contributing category may pertain to the various stages of the industrial process being carried out in the facility of the organization. The percentage contribution of greenhouse gas emissions contributed by the contributing category may be referred to as a second weighted distribution.

At block 606, emission may be estimated. In one example, with the percentage contribution of emissions of the source level category and the contributing category obtained, the system 102 may estimate a volume or quantity of emission attributable to the source level category and the contributing category. The estimation may be based on a production plan depicting a predefined quantity of goods to be manufactured by the organization.

At block 608, once the estimation is completed, an operating parameter may be modified. For example, the system 102 may determine whether the emission of the source level category is greater than a predefined threshold. If the source level category is greater than the predefined threshold, an operating parameter of the asset contributing to the source level category of greenhouse gas emissions, may be modified. For example, the operating parameter may be one of a temperature, pressure, duty cycle, and load capacity of the asset operating during industrial process. Examples of such an operating parameter includes, but is not limited to, supplementing the process with additional measures or deploying additional equipment or components to treat the emissions for reducing the quantity of the greenhouse gases therein. In another example, when the predefined threshold is exceeded, the system 102 may generate an alert for a given asset. The alert may be depicted by way of a visual indication a dashboard.

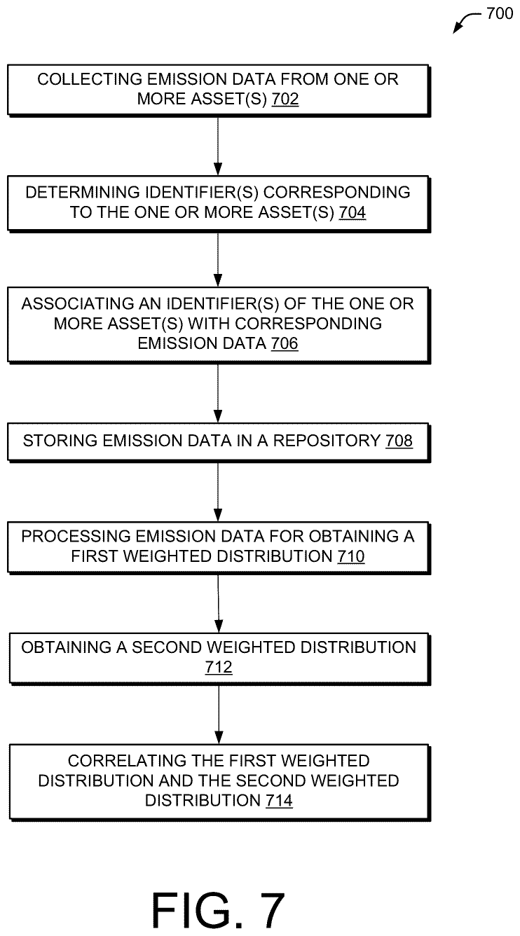

FIG. 7 illustrates a method for estimation of greenhouse gas emissions, as per an example. The order in which the above-mentioned methods are described is not intended to be construed as a limitation, and some of the described method blocks may be combined in a different order to implement the method, or an alternative method.

In an example, the above-mentioned methods may be implemented by an emission estimation engine (such as emission estimation engine 412) of the system 102 for estimation of emissions. The above-mentioned methods are explained from the perspective of a process, for example, process 204 implemented within an organization, such as organization 302. Although the present explanation is provided in relation to the estimation of emissions by determining a first weighted distribution and a second weighted distribution, these approaches may also be applicable for a greater number of weighted distributions. Such implementations too would fall within the scope of the present subject matter.

At block 702, emission data may be collected. In one example, the emission estimation engine 412 may collect emission data, such as emission data 212 from one or more asset(s), such as asset(s) 206. As discussed previously, the processes 204 may be implemented through one or more asset(s) 206. For example, facility 202-1 of the organization 302 may include multiple asset(s) 206-1, 2, 3, and 4. The operation of the asset(s) 206 may, over a period, produce gaseous emissions which may comprise one or more types of greenhouse gases. Assets may include any machinery, vehicles, or equipment that is used in a commercial or industrial facility or organization.

Further, one or more sensors may be installed in each of the asset(s) 206. The sensors, besides monitoring various operational parameters of the assets, may monitor and measure the volume of the greenhouse gas emissions that may be produced by each of the respective asset(s) 206. For example, if asset is a conduit for carrying oil (or any other fluid), the sensors may monitor and determine fill level, flow rate, pressure, and/or temperature sensors.

At block 704, an identifier may be determined. For example, one or more identifiers may be determined, which are to indicate the asset (from amongst the asset(s) 206) to which the emission data corresponds with. The sensors may monitor and determine the quantity of the emissions that may be produced by the respective asset(s) 206, pertinent to which the respective identifier may be determined.

At block 706, identifier of the asset(s) may be associated or linked with the corresponding data collected from them. For example, once determined, the estimation engine 218 may tag the identifier with the emission data 212 that is collected the asset(s) 206. As may be understood, the associated identifier may indicate the asset (from amongst the asset(s) 206) to which the emission data corresponds with.

At block 708, emission data (which is linked with the identifier of the asset(s)) may be stored in a repository. In one example, the emission data 212 obtained from the one or more asset(s) 206 may thereafter be communicated via a network, such as network 208 to a data repository, such as data repository 210. The emission data 212 may thus include data pertaining to the volume of the emissions produced by each of the asset(s) 206 (as denoted by the corresponding identifier). Since the emission information within the emission data 212 is linked to each of the asset(s) 206, the emission data 212 thus includes, at a granular level, asset-specific contribution of each of the asset(s) 206 to the total emissions by the organization 302.

At block 710, emission data may be processed to obtain a first weighted distribution. As explained previously, the emission data 212 includes data pertaining to the volume of the emissions produced by each of the asset(s) 206. The emission data 212 thus includes, at a granular level, asset-specific contribution of each of the asset(s) 206 to the total emissions by the organization 302. In an example, the estimation engine 218 may process the emission data 212 to determine a first weighted distribution 416. Based on the proportion of the emission data 212 attributable to the asset 206-1 (i.e., for the ‘storage tank flashing’) to the stage, ‘venting’ (which is the contributing category), the estimation engine 412 may determine a percentage contribution of the asset 206-1 (i.e., the source level category) to ‘venting’ (i.e., the contributing category). In a similar manner, a percentage contribution may be determined for all the asset(s) 206 at the source level category. Once determined, the first weighted distribution 416 depicting percentage contribution of the source level category (i.e., the asset(s) 206) to the emissions of the contributing category may be stored within the system 102.

At block 712, a second weighted distribution may be obtained. Once the first weighted distribution 416 is determined, the estimation engine 412, based on the volume of emissions attributed to each of the contributing category, may determine the second weighted distribution 418 which depicts a percentage or proportion of the emissions of the contributing category to the overall emissions. The overall emissions may be produced by an emission source, which may be one of a direct emission source (e.g., as defined under Scope 1 emission of the greenhouse gas protocol) or an indirect emission source (e.g., as defined under Scope 2/3 of the greenhouse gas protocol). Similar to the first weighted distribution 416, a higher value of the second weighted distribution 418 implies that the contributing category (for which the value of the second weighted distribution 418 was higher) is a prominent contributor to the emissions (either one of Scope 1, 2, or 3).

At block 714, the first weighted distribution and the second weighted distribution may be correlated with the quantity of goods manufactured. For example, the estimation engine 218 may correlate the first weighted distribution 416 and the second weighted distribution 418 the quantity of goods being manufactured (which resulted in said emissions represented by emission data 212). Once the first weighted distribution 416 and the second weighted distribution 418 are determined, the same may be used as a basis for distributing the emission intensity value, corresponding to given quantity of product, across the source level category as well as the contributing category.

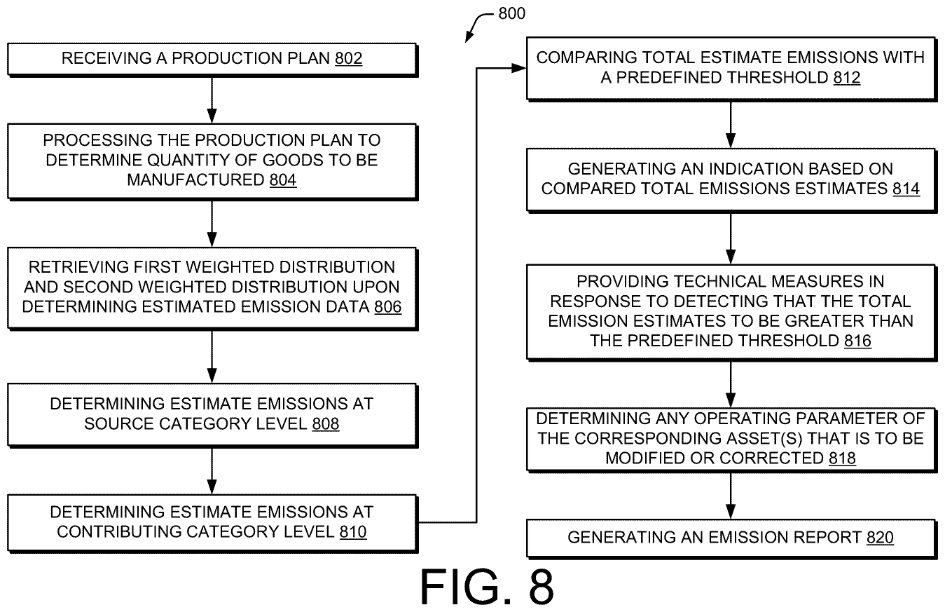

FIG. 8 illustrates a method for estimation of greenhouse gas emissions, as per an example. The order in which the above-mentioned methods are described is not intended to be construed as a limitation, and some of the described method blocks may be combined in a different order to implement the method, or an alternative method.

At block 802, a production plan may be received. In an example, a production plan, such as production plan 304 may be received, specifying a production objective. The production objective may specify the quantity of goods that may have been produced or manufactured using or involving the different asset(s) 206. It is these goods, the manufacturing of which would have resulted in the emissions recorded as emission data 212.

At block 804, the production plan may be processed to determine the goods and/or quantity of goods to be manufactured. For example, once received, the estimation engine 412 may process the received production plan 422 to determine the goods and the quantity of goods that have to be manufactured. As the quantity of any given goods are correlated with the estimated emission data 424 that may be produced by the organization 302, the estimation engine 412 based on the quantity of the goods indicated in the production plan 422, may estimate the estimated emission data 424 that would be generated if the production plan 422 is implemented.

At block 806, upon determining the estimated emission data, the first weighted distribution and the second weighted distribution are retrieved. For example, the estimation engine 412 may retrieve the first weighted distribution 416 and the second weighted distribution 418, once the estimated emission data 424 is determined. The first weighted distribution 416 and the second weighted distribution 418 were determined based on the approaches described in conjunction with FIG. 7.

At block 808, estimate emissions at source level may be determined. For example, the estimation engine 218 using the estimated total emissions (that were determined based on the production plan), the first weighted distribution 416 and the second weighted distribution 418, determines the estimate emissions at the source level, i.e., for the asset(s) 206, as well as for the contributing categories for the organization 302. The estimate emissions determined based on the first weighted distribution 416 and the second weighted distribution 418 thus provide a granular level estimation of the contribution not only at the level of the asset(s) 206, but also at the level of the each of the contributing categories, to which the asset(s) 206 may pertain to.

At block 810, estimate emissions at contributing categories level may be determined. The estimation engine 412 additionally also determines the net emissions that may be produced if the production as per the received production plan 422 is completed. In this manner, the system 102 is to determine the emissions estimates for not only the asset(s) 206 but also for each of the contributing categories, as described in the examples above. It may be noted that the above approaches are applicable for any other organizations or facilities that may be engaged in activities pertaining to other types of products. In instances where any organization 302 is producing multiple types of products, the above approaches are capable of providing estimated emissions for asset(s) 206 and/or the corresponding contributing category which may be involved in the manufacturing of such products. In an example, the estimated emissions for both the source level and the contributing level category may be stored in in the estimated emission data 424, with each estimated emission being tagged with an identifier indicating the asset(s) 206 to which the estimates pertain to.

At block 812 the total emissions estimates may be compared with predefined thresholds. For example, the estimation engine 412 may determine the total emissions estimates (i.e., the sum of prior emission estimates as well as the estimated emission data 424) to further ascertain whether the organization 302 is likely to exceed committed emission thresholds. To this end, the estimation engine 412 may compare the total emission estimates with a predefined threshold. The predefined threshold, in an example, may correspond to the committed emissions that may have been submitted (say as part of regulatory compliance or prevailing regulations).

At block 814, an indication may be generated based on the comparison of the total emissions estimate. For example, the estimation engine 412 may generate an indication corresponding to the relative status of the total emissions that are likely to be produced by the organization 302. If the total emission estimates are less than the predefined threshold, the estimation engine 412 may generate an indication which reflects a deficit value, which is the difference between the total emission estimates and the predefined threshold. It may also be the case that the total emission estimates are greater than the predefined threshold. In such a case, the estimation engine 412 may generate a visual or audio alert to indicate that the total emission estimates, if the production plan 422 is completed, are likely to exceed the committed emissions as may have been submitted by the organization 302, say as part of the regulatory compliances.

At block 816, technical measures in response to detecting that the total emission estimates are greater than the predefined threshold may be provided. For example, on detecting that the total emission estimates are greater than the predefined threshold, the estimation engine 412 may retrieve the estimated emission data 424 for each of the asset(s) 206. Once retrieved, the estimated emission data 424 may be compared with a second predefined threshold which may be associated for each of the asset(s) 206. Based on the comparison, the estimation engine 412 may identify such asset(s) 206 for which the estimated emission data 424 is greater than the second predefined threshold.

At block 818, any operating parameter of the corresponding asset(s) that is to be modified or corrected, may be determined. To this end, the estimation engine 412 may determine whether any operating parameter of the corresponding asset(s) 206, i.e., the asset 206-1, has to be modified or corrected to enable reducing the estimated emissions. For example, the estimation engine 412 may cause the asset 206-1 to power down when not used for certain periods of time. In another example, the estimation engine 412 may also recommend supplementing the asset 206-1 with components that may cause reduction in the emission estimates. The recommendations provided by the estimation engine 412 may be based on previously prescribed suggestive actions that may be undertaken. In addition, the estimation engine 412 may also recommend one or more corrective maintenance procedures to be performed which are like to reduce the emissions that may be generated for the asset 206-1.

At block 820, an emission report may be generated. For example, the emission estimates may be captured and presented within an emission report 308. In an example, the emission estimates provided by the system 102 may provide contribution to the total emission emissions associated with the contributing category and the source level category, as obtained respective to the production plan 304. In an example, the extent of contribution may be indicated as first weighted distribution and a second weighted distribution.

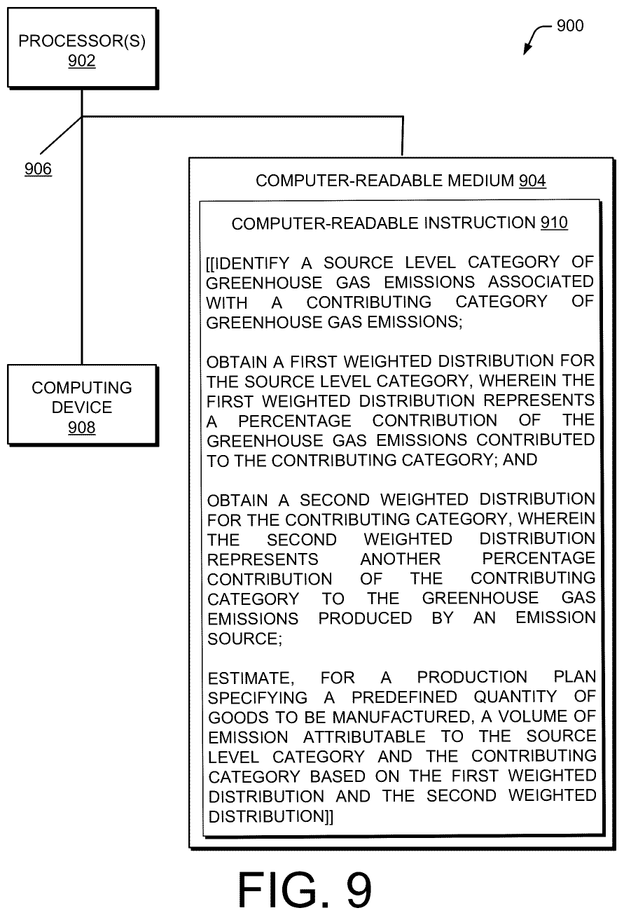

FIG. 9 illustrates a non-transitory computer-readable medium 900 for estimation of emissions, in accordance with an example of the present subject matter. In an example, the non-transitory computer-readable medium 900 includes processor 902 communicatively coupled to a non-transitory computer readable medium 904 through communication link 906. In an example, the processor 902 may have one or more processing resources for fetching and executing computer-readable instructions from the non-transitory computer readable medium 904. The processor 902 and the non-transitory computer readable medium 904 may be implemented, for example, in the emission estimation system 102.

The non-transitory computer readable medium 904 may be, for example, an internal memory device or an external memory. In an example implementation, the communication link 906 may be a network communication link, or other communication links, such as a PCI (Peripheral component interconnect) Express, USB-C(Universal Serial Bus Type-C) interfaces, I2C (Inter-Integrated Circuit) interfaces, etc. In an example implementation, the non-transitory computer readable medium 904 includes a set of computer readable instructions 910 which may be accessed by the processor 902 through the communication link 906 and subsequently executed for reconfiguring the data pipeline. The processor(s) 902 and the non-transitory computer readable medium 904 may also be communicatively coupled to a computing device 908 over the network.

Referring to FIG. 9, in an example, the non-transitory computer readable medium 904 includes computer readable instructions 910 that cause the processor 902 to identify a source level category of greenhouse gas emissions associated with a contributing category of greenhouse gas emissions, wherein the source level category contributes to overall greenhouse gas emission of the contributing category. The source level category is such that it contributes to overall greenhouse gas emission of the contributing category. In an example, the contribution of greenhouse gas emissions of the source level category is related with an asset. Examples of an asset includes, but is not limited to, machinery, or equipment that may be used for implementing the process. In an example, the source level category contributes to overall emissions of the contributing category.

For example, each facility 202 may operate depending on the production objectives as defined in a production plan. Manufacturing facilities within an organization may plan their operations based on a production plan. The instructions 910 may further cause the processor 902 to obtain a first weighted distribution for the source level category, wherein the first weighted distribution represents a percentage contribution of the greenhouse gas emissions contributed to the contributing category.

Further, the instructions 910 may cause the processor 902 to obtain a second weighted distribution for the contributing category, wherein the second weighted distribution represents another percentage contribution of the contributing category to the greenhouse gas emissions produced by an emission source. For example, once the values of greenhouse gas emissions for the source level category are obtained, the instructions 910 may obtain another percentage contribution of the contributing category. The contributing category may pertain to the various stages of the industrial process being carried out in the facility of the organization. The percentage contribution of greenhouse gas emissions contributed by the contributing category may be referred to as a second weighted distribution.

The instructions 910 may further cause the processor 902 to estimate, for a production plan specifying a predefined quantity of goods to be manufactured, a volume of emission attributable to the source level category and the contributing category based on the first weighted distribution and the second weighted distribution, determine whether the emission of the source level category is greater than a predefined threshold, and modify an operating parameter of an asset contributing to the source level category of greenhouse gas emissions.

Although examples of the present subject matter have been described in language specific to methods and/or structural features, it is to be understood that the present subject matter is not limited to the specific methods or features described. Rather, the methods and specific features are disclosed and explained as examples of the present subject matter.

1. A system comprising:
a processor; and
a machine-readable storage medium comprising instructions executable by the processor to:
identify a source level category of greenhouse gas emissions associated with a contributing category of the greenhouse gas emissions, wherein the source level category contributes to overall greenhouse gas emission of the contributing category.
obtain a first weighted distribution for the source level category, wherein the first weighted distribution represents a percentage contribution of the greenhouse gas emissions contributed to the contributing category.
determine a second weighted distribution for the contributing category, wherein the second weighted distribution represents another percentage contribution of the contributing category to the greenhouse gas emissions produced by an emission source;
estimate, for a production plan specifying a predefined quantity of goods to be manufactured, a volume of emission attributable to the source level category and the contributing category based on the first weighted distribution and the second weighted distribution;
determine whether the emission of the source level category is greater than a predefined threshold; and
cause to modify an operating parameter of an asset contributing to the source level category of the greenhouse gas emissions.

2. The system as claimed in claim 1, wherein the asset is one of a machinery, equipment, and infrastructure components operating within an industrial process for production of goods.

3. The system as claimed in claim 1, wherein the contributing category corresponds to stages of industrial process for production of goods.

4. The system as claimed in claim 1, further comprises:
generate an alert indicating the asset for which the emission of the source level category is greater than the predefined threshold; and
recommend a compensatory control to be implemented related to modifying the operating parameter of the asset.

5. The system as claimed in claim 1, wherein the emission source is one of a direct emission source and an indirect emission source as defined under greenhouse gas protocol.

6. The system as claimed in claim 5, wherein the direct emission source is defined under Scope 1 emission of the greenhouse gas protocol, and wherein the indirect emission source is defined under one of Scope 2 emission and Scope 3 emission of the greenhouse gas protocol.

7. The system as claimed in claim 1, wherein the first weighted distribution and the second weighted distribution is obtained by correlating historic data pertinent to the greenhouse gas emissions being produced from the source level category and the contributing category, respectively, to the predefined quantity of goods to be produced according to the production plan.

8. The system as claimed in claim 1, wherein the estimation of the volume of the emission attributable to the source level category and the contributing category is based on training a machine learning model, wherein the machine learning model is trained based on a dataset respective to the first weighted distribution and the second weighted distribution, respectively.

9. The system as claimed in claim 1, wherein the production plan is to specify a change in production quantity of the goods for a certain predefined time.

10. The system as claimed in claim 1, wherein the instructions are executable by the processor to further process values corresponding to the volume estimated of emission attributable to the source level category and the contributing category, to provide segregated values for different organizational level of an organization implementing an industrial process for production of goods.

11. The system as claimed in claim 1, wherein the instructions are executable by the processor to further:
render a display on a dashboard depicting one or more informational sections indicative of a total production section, a total estimated emission section, a distribution of emission section, a first weighted distribution section, a second weighted distribution section, and combinations thereof.

12. A method comprising:
obtaining, based on historic data, values of greenhouse gas emissions for a source level category associated with a contributing category of greenhouse gas emissions, wherein the source level category contributes to overall greenhouse gas emission of the contributing category,
wherein the values of the greenhouse gas emissions of the source level category indicates a percentage contribution of greenhouse gas emission contributed to the contributing category;
determining, based on the historic data, values of the greenhouse gas emissions for the contributing category, wherein the values of the greenhouse gas emissions of the contributing category indicates another percentage contribution of the contributing category to the greenhouse gas emissions produced by an emission source;
obtaining based on the values of the greenhouse gas emissions for the source level category and the contributing category, an estimated emission, wherein the estimated emission is indicative of a volume of emission attributable of the source level category and the contributing category to the emission source; and
modifying an operating parameter of an asset contributing to the source level category of greenhouse gas emissions when it is determined that the emission of the source level category is greater than a predefined threshold.

13. The method as claimed in claim 12, wherein the values of the greenhouse gas emissions are obtained from one or more sensors associated with the asset, wherein the one or more sensors are to monitor operational parameters of the asset and measure the volume of emission attributable of the asset.

14. The method as claimed in claim 13, wherein when the predefined threshold is exceeded, the method further comprises:
generating an alert indicating the asset for which the emission of the source level category was greater than the predefined threshold; and
recommending a compensatory control to be implemented related to modifying the operating parameter of the asset.

15. The method as claimed in claim 13, wherein the operating parameter is one of a temperature, pressure, duty cycle, and load capacity of the asset operating during industrial process.

16. A non-transitory computer-readable medium comprising instructions, the instructions being executable by a processing resource to:
identify a source level category of greenhouse gas emissions associated with a contributing category of the greenhouse gas emissions, wherein the source level category contributes to overall greenhouse gas emission of the contributing category;
obtain a first weighted distribution for the source level category, wherein the first weighted distribution represents a percentage contribution of the greenhouse gas emissions contributed to the contributing category;
obtain a second weighted distribution for the contributing category, wherein the second weighted distribution represents another percentage contribution of the contributing category to the greenhouse gas emissions produced by an emission source;
estimate, for a production plan specifying a predefined quantity of goods to be manufactured, a volume of emission attributable to the source level category and the contributing category based on the first weighted distribution and the second weighted distribution;
determine whether the emission of the source level category is greater than a predefined threshold; and
cause to modify an operating parameter of an asset contributing to the source level category of the greenhouse gas emissions.

17. The non-transitory computer-readable medium as claimed in claim 16, further comprises:
cause to generate an alert indicating the asset for which the emission of the source level category was greater than the predefined threshold; and
recommend a compensatory control to be implemented related to modifying the operating parameter of the asset.

18. The non-transitory computer-readable medium as claimed in claim 16, wherein the estimation of the volume of the emission attributable to the source level category and the contributing category is based on training a machine learning model, and wherein the machine learning model is trained based on a dataset respective to the first weighted distribution and the second weighted distribution, respectively.

19. The non-transitory computer-readable medium as claimed in claim 16, wherein the first weighted distribution and the second weighted distribution is obtained by correlating historic data pertinent to the greenhouse gas emissions being produced from the source level category and the contributing category, respectively, to the predefined quantity of goods to be produced according to the production plan.

20. The non-transitory computer-readable medium as claimed in claim 16, wherein the instructions are further executable by the processing resource to:
render a display on a dashboard depicting one or more informational sections indicative of one of a total production section, a total estimated emission section, a distribution of emission section, a first weighted distribution section, a second weighted distribution section, and combinations thereof.
